(19) United States
(12) Patent Application Publication
(10) Pub. No.: US 2007/0013884 A1
(43) Pub. Date: Jan. 18, 2007

(54) Method for exposing an object to light and exposure apparatus for performing the same

(75) Inventor: Hak Kim, Yongin-si (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 11/482,747

(22) Filed: Jul. 10, 2006

(30) Foreign Application Priority Data
Jul. 14, 2005 (KR) 10-2005-0063581

(51) Int. Cl. G03B 27/42

(52) U.S. Cl. 355/53; 355/67

(57) ABSTRACT

In a method for exposing an object to light and an exposure apparatus for performing the method, projection lights having image information may be produced. The projection lights may be projected onto the film on the substrate and travel along separately advancing paths. The advancing paths may not intersect with each other. To produce the projection light, illumination light beams proceeding along separately advancing paths may be produced. Thereafter, reticle patterns may transmit the illumination light beams. The reticle patterns may move in a first direction, and the substrate may move in a second direction opposite the first direction. The illumination light beams may be produced by separating an initial light. The projection lights may be projected onto the film at the same time or different times.

### PRIORITY STATEMENT

This application claims benefit of priority under 35 U.S.C. § 119 to Korean Patent Application No. 2005-63581 filed on Jul. 14, 2005, the entire contents of which is incorporated herein by reference.

### BACKGROUND OF THE INVENTION

1. Field of the Invention

Example embodiments of the present invention relate to methods for exposing an object to light and exposure apparatuses. More particularly, example embodiments of the present invention relate to methods for projecting an image of a reticle pattern onto a film on a substrate using light and exposure apparatuses for performing these methods.

2. Description of the Related Art

A conventional photolithography process may include a coating process, a baking process, an exposure process and a development process. A substrate may be coated with a photoresist composition using a coating process to form a preliminary photoresist film on the substrate. The preliminary photoresist film may be hardened using a baking process to change the preliminary photoresist film into a photoresist film. Reticle pattern images of reticle patterns of a reticle may be projected onto the photoresist film using an exposure process. The photoresist film may be at least partially removed using a development process to change the photoresist film into photoresist patterns.

A conventional exposure apparatus used to perform an exposure process of the photolithography process may include a light source, an illumination unit, a reticle stage, a project optical unit and a substrate stage. The illumination unit may change point lights irradiated from the point light source into flat lights and may condense the flat lights. The reticle stage may support a reticle. The project optical unit may provide the photoresist film on the substrate with the flat light transmitted through the reticle. The substrate stage may support the substrate. The reticle may be located over the project optical unit, and the photoresist film on the substrate may be located under the project optical unit.

Using a conventional exposure apparatus, a point light irradiated from the light source may be changed into the flat light. Thereafter, the flat light may be condensed. The flat light may then be incident on a reticle. Because the reticle may have reticle patterns, the flat light transmitted through the reticle may have image information corresponding to the reticle patterns. The flat light having the image information may be passed through the project optical unit and may be incident on the photoresist film arranged on the substrate.

In general, a semiconductor device may be manufactured using various processes including, but not limited to, an ion implantation process, a deposition process, a diffusion process and a photolithography process. The photolithography process may be performed to form photoresist patterns on a substrate.

The photoresist film may be divided into shoot regions. The photoresist patterns may be formed within the shoot region. The number of the shoot regions and size of the shoot regions may be determined by the type(s) of semiconductor device(s) formed using the photoresist patterns. The exposure process may include a first exposure step and a second exposure step. The first exposure step may be performed on the shoot regions formed over a central portion of the substrate, and the second exposure step may be performed on the shoot regions formed over an edge portion of the substrate. That is, the second exposure step may be performed to selectively remove the shoot regions formed over the edge portion of the substrate.

In a conventional exposure process using a conventional exposure apparatus, the first exposure step is may be performed using the reticle having reticle patterns and the second exposure step may be performed using a non-patterned reticle that does not have reticle patterns. After the first exposure step is finished, the non-patterned reticle may be substituted for the patterned reticle. The second exposure step may then be performed in a conventional exposure process. After the second exposure step is finished, the reticle may be substituted for the non-patterned reticle. Thereafter, the first exposure step may be performed on a subsequent substrate. Accordingly, an alignment process may be performed between the first and second exposure steps in a conventional exposure process.

Time and cost required for changing the reticles and performing the alignment process may be long and expensive, respectively. To overcome the above problems, conventional technologies using two reticles have been developed. However, in these conventional technologies, reticle images are merged before the reticle images are projected onto a film arranged on a substrate. That is, the reticle images are merged by a project optical system. Thereafter, the reticle images are focused on a region of the film arranged on the substrate. When reticle images are merged, the reticle images may interfere with each other. Thus, resolution of the reticle images may be degraded. That is, if reticle images are projected onto the film on the substrate using the conventional technologies, the time and cost required for projecting the reticle images onto the film on the substrate may be unnecessarily long and expensive, respectively, and/or the reticle images may not be precisely projected onto the film on the substrate.

### SUMMARY OF THE INVENTION

Some example embodiments of the present invention provide methods for exposing an object to light, which may efficiently project images of at least two reticles onto the object. The object may be a film on a substrate.

Some example embodiments of the present invention provide exposure apparatuses for exposing objects to light.

An example embodiment of the present invention provides methods for exposing a film on a substrate to light. In the methods, projection lights having image information may be produced. The projection lights may be projected onto the film on the substrate along separately advancing paths. The advancing paths may not intersect with each other. To produce the projection light, illumination light beams proceeding along the separately advancing paths may be produced. Thereafter, reticle patterns may transmit the illumination light beams. The reticle patterns may move in a first direction, and the substrate may move in a second direction substantially opposite to the first direction. The illumination light beams may be produced by separating an initial light. The projection lights may be projected onto the film at the same time or different times.

An example embodiment of the present invention provides an exposure apparatus. The exposure apparatus may include a first optical section and a second optical section. The first optical section may produce projection lights having image information. The second optical section may project the projection lights that advance along separate paths onto a film on a substrate. The first optical section may include an illumination module, a first reticle and a second reticle. The illumination module may produce first and second illumination light beams. The first reticle may have first reticle patterns and may transmit the first illumination light beam to change the first illumination light beam into a first projection light having first reticle pattern image information of the first reticle patterns. The second reticle may have second reticle patterns and may transmit the second illumination light beam to change the second illumination light beam into a second projection light having second reticle pattern image information of the second reticle patterns.

According to an example embodiment of the present invention, the illumination module may include a first light source and a second light source. The first light source may produce the first illumination light beam. The second light source may produce the second illumination light beam.

According to an example embodiment of the present invention, the illumination module may include a light source and at least one beam splitter. The light source may produce an initial light. The beam splitter may separate the initial light into the first and second illumination light beams.

According to an example embodiment of the present invention, the exposure apparatus may further include a first illumination screen and a second illumination screen. The first illumination screen may be installed between the illumination module and the first reticle. The first illumination screen may have a first light transmission slit having a substantially rectangular shape. The second illumination screen may be installed between the illumination module and the second reticle. The second illumination screen may have a second light transmission slit having a substantially rectangular shape. The exposure apparatus may further include a first blinder set and a second blinder set. The first blinder set may be installed at the first illumination screen to adjust a width of the first light transmission slit. The second blinder set may be installed at the second illumination screen to adjust a width of the second light transmission slit. The exposure apparatus may further include a first reticle stage and a second reticle stage. The first reticle stage may move the first reticle in a direction substantially perpendicular to an incident direction of the first illumination light beam. The second reticle stage may move the second reticle in a direction substantially perpendicular to an incident direction of the second illumination light beam. The second optical section may include a condense module and a project screen. The condense module may condense the projection lights. The project screen may be located over the film on the substrate. The project screen may have a slit through which the projection lights are transmitted, the slit having a substantial rectangle shape. The condense module may include a reduction mirror having a substantially hemispheric shape. The exposure apparatus may further include a sensor module installed at the project screen. The sensor module may send a signal toward the film on the substrate to measure a distance between the project screen and the film on the substrate. The exposure apparatus may further include a substrate stage. The substrate stage may support the substrate. The substrate state may move the substrate horizontally.

According to an example embodiment of the present invention, images of at least two reticles may be rapidly projected onto a film on a substrate. In addition, the images may not interfere with each other. Thus, superior photoresist patterns may be formed. In addition, a resolution margin of an exposure apparatus may be about twice a conventional resolution margin of a conventional exposure apparatus. As a result, a superior exposure effect may be obtained in a relatively short time. That is, a large amount of the superior photoresist patterns may be rapidly obtained.

### BRIEF DESCRIPTION OF THE DRAWINGS

The above and other features and advantages of the present invention will become readily apparent to one skilled in the art by considering the following detailed description of example embodiments of the present invention in conjunction with the accompanying drawings in which:

FIG. 1 is a cross-sectional view illustrating an exposure apparatus according to an example embodiment of the present invention;

FIG. 2 is a plan view illustrating a first illumination screen in FIG. 1 according to an example embodiment of the present invention;

FIG. 3 is a plan view illustrating a project screen in FIG. 1 according to an example embodiment of the present invention;

FIG. 4 is a flow chart illustrating a method for exposing a film on a substrate to light according to an example embodiment of the present invention;

FIG. 5 is a schematic view illustrating first reticle pattern images according to an example embodiment of the present invention shown in FIG. 4;

FIG. 6 is a schematic view illustrating second reticle pattern images according to an example embodiment of the present invention shown in FIG. 4; and

FIG. 7 is a schematic view illustrating third reticle pattern images projected onto a film on a substrate according to an example embodiment of the present invention shown in FIG. 4.

### DETAILED DESCRIPTION OF EXAMPLE EMBODIMENTS

Example embodiments of the present invention are described below with reference to the accompanying drawings. The present invention may, however, be embodied in many different forms and should not be construed as limited to the example embodiments described herein. Rather, the example embodiments are provided so that disclosure of the present invention will be thorough, complete and fully convey the scope of the present invention to those skilled in the art. The principles and features of this invention may be employed in varied and numerous embodiments without departing from the scope of the present invention. In the drawings, the size and relative sizes of films and regions are exaggerated for clarity. The drawings are not to scale. Like reference numerals designate like elements throughout the drawings.

It will also be understood that when an element or film is referred to as being “on” another element or film, the element or film may be directly on the other element or film or intervening elements or films may be present. As used herein, the term “and/or” may include any and all combinations of one or more of the associated listed items.

It will also be understood that, although the terms first, second, etc. may be used herein to describe various elements, components, regions and/or sections. These elements, components, regions and/or sections should not be limited by these terms. These terms may be used to distinguish one element, component, region and/or section from another element, component, region and/or section. For example, a first element, component, region and/or section discussed below could be termed a second element, component, region and/or section without departing from the teachings of the present invention.

The terminology used herein is for the purpose of describing particular example embodiments and is not intended to limit of the invention. As used herein, the singular terms “a,” “an” and “the” are intended to include the plural forms as well, unless the context clearly indicates otherwise. It will be further understood that the terms “includes” and/or “including”, when used in this specification, specify the presence of stated features, integers, steps, operations, elements, components and/or groups thereof, but do not preclude the presence and/or addition of one or more other features, integers, steps, operations, elements, components, and/or groups thereof.

Unless otherwise defined, all terms (including technical and scientific terms) used herein may have the same meaning as what is commonly understood by one of ordinary skill in the art. It will be further understood that terms, such as those defined in commonly used dictionaries, should be interpreted as having a meaning that is consistent with their meaning in the context of the relevant art and will not be interpreted in an idealized and/or overly formal sense unless expressly so defined herein.

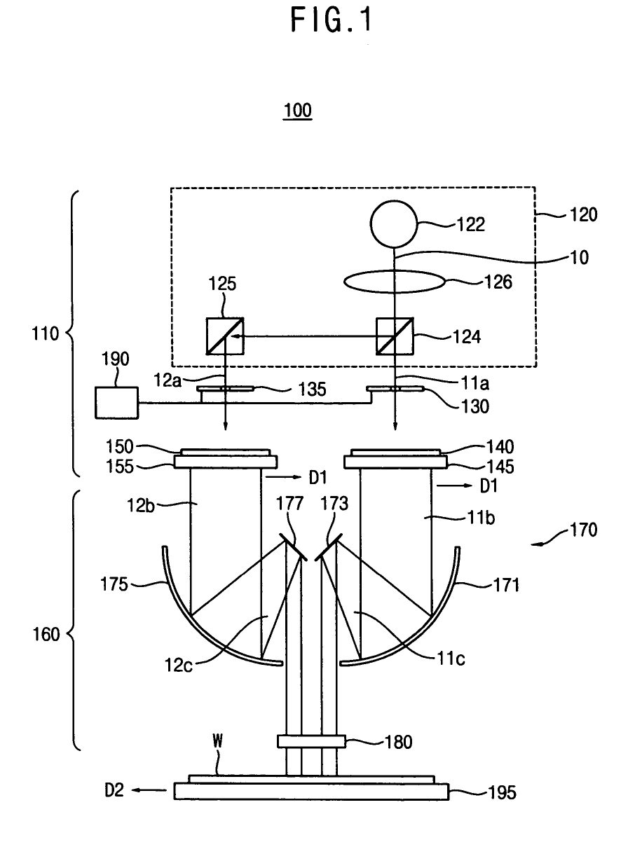

FIG. 1 is a cross-sectional view illustrating an exposure apparatus in accordance with an example embodiment of the present invention.

Referring to FIG. 1, a photoresist film (not shown) may be formed on a substrate W. An exposure process and/or a development process may be performed on the photoresist film to form photoresist patterns. The substrate W may be coated with a photoresist composition during a coating process to form a preliminary photoresist film on the substrate W. Then, a soft bake process may be performed on the preliminary photoresist to form the photoresist film. Photoresist patterns may be used as an etch mask and/or an ion implantation mask.

According to an example embodiment of the present invention, the photoresist film on the substrate W may include a plurality of shoot regions. Each shoot region may have at least one die region. A size of the die region may be determined by the type(s) of semiconductor device(s) formed using the photoresist film on the substrate W. The number of the die regions and the size of the die regions may determine a size of the shoot region including the die regions.

An exposure apparatus 100 may include a first optical section 110 and a second optical section 160 according to an example embodiment of the present invention.

The first optical section 110 may produce first and second projection lights 11b and 12b. The first projection light 11b and the second projection light 12b may have first reticle pattern image information and second reticle pattern image information, respectively. The first optical section 110 may include an illumination module 120, a first illumination screen 130, a second illumination screen 135, a first reticle 140, a first reticle stage 145, a second reticle 150 and a second reticle stage 155.

The illumination module 120 may produce first and second illumination light beams 11a and 12a. The first and second illumination light beams 11a and 12a may include deep ultraviolet rays having wavelengths ranging from about 100 nm to about 300 nm or extreme violet rays having wavelengths no more than about 100 nm. According to an example embodiment of the present invention, the first and second illumination light beams 11a and 12a may have substantially the same wavelengths and intensities or substantially different wavelengths and intensities.

The first and second illumination light beams 11a and 12a may be produced by a single light source 122. For example, in FIG. 1, an initial light 10 produced by the single light source 122 is separated into the first and second illumination light beams 11a and 12a in the illumination module 120. Alternatively, the first and second illumination light beams 11a and 12a may be produced by separated light sources. However, if the first and second illumination light beams 11a and 12a are produced by the single light source 122, a dimension of the exposure apparatus 100 and a cost required for manufacturing the exposure apparatus 100 may be reduced.

One skilled in the art will understand that many apparent variations of the illumination module 120 are possible without departing from the spirit or scope of the present invention. For example, the number of illumination light beams separated from the initial light 10 may be substantially the same as the number of reticles included in the exposure apparatus 100.

As described above, a single light source 122 may produce the initial light 10 according to an example embodiment of the present invention. The single light source 122 may include an argon fluoride (ArF) excimer laser source, a krypton fluoride (KrF) excimer laser source, a fluoride (F₂) laser source, an yttrium aluminum gamet (YAG) laser source or a mercury lamp, for example.

According to an example embodiment of the present invention, a first beam splitter 124 may be arranged in an advancing path of the initial light 10 produced from the single light source 122. The first beam splitter 124 may reflect a portion of the initial light 10 and transmit a remaining portion of the initial light 10 to produce the first illumination light beam 11a. A second beam splitter 125 may be arranged in an advancing path of the portion of the initial light 10 reflected by the first beam splitter 124. The second beam splitter 125 at least partially reflects the portion of the initial light 10 reflected by the first beam splitter 124 to produce the second illumination light beam 12a. The first and second illumination light beams 11a and 12a may have substantially the same intensities or substantially different intensities. According to an example embodiment of the present invention, first reticle patterns and the second reticle patterns may determine the intensities of the first and second illumination light beams 11a and 12a. The first and second beam splitters 124 and 125 may be five-to-five (5:5) beam splitters widely used in an exposure apparatus and/or an inspection apparatus.

As described above, the first and second beam splitters 124 and 125 may be utilized to produce the first and second illumination light beams 11a and 12a, respectively. Alternatively, a reflection mirror may be substituted for the second beam splitter 125. In this case, the portion of the initial light 10 reflected by the first beam splitter 124 may also be reflected by the reflection mirror so that the second illumination light beam 12a may be produced. That is, the portion of the initial light 10 reflected by the first beam splitter 124 may correspond to the second illumination light beam 12a and the portion the initial light 10 transmitted through the first beam splitter 124 may correspond to the first illumination light beam 11a.

The illumination module 120 may also include an optical system 126. The optical system 126 may allow the advancing directions of the first and second illumination light beams 11a and 12a to be substantially parallel with each other. In addition, the optical system 126 may ensure that the first and second illumination light beams may have substantially the same luminous intensities if desired. Examples of the optical system 126 include a beam matching unit (BMU), a variable beam attenuator, a beam shaping optical system, a fly-eye lens, a condenser lens, etc. As described above, the first and second illumination light beams 11a and 12a incident on first and second screens 130 and 135, respectively, may be substantially parallel with each other. The substantially parallel directions of the first and second illumination beams 11a and 12a may be aided and/or controlled by the optical system 126. In addition, the optical system 126 may aid and/or control the first and second illumination light beams 11a and 12a to have substantially the same luminous intensities according to an example embodiment of the present invention.

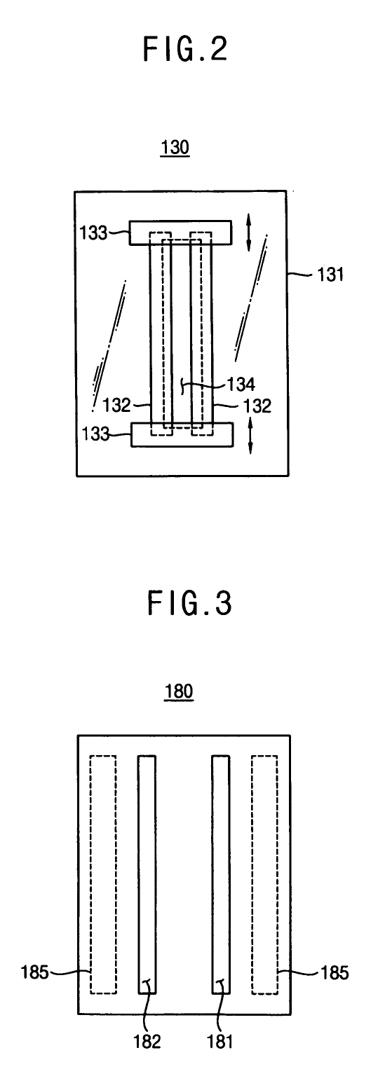

According to an example embodiment of the present invention, the first and second illumination screens 130 and 135 may control sectional areas of the first and second illumination light beams 11a and 12a, respectively. The first illumination screen 130 may be structurally the same as the second illumination screen 135. In addition, the first and second illumination screens 130 may have substantially the same functions. The first illumination screen 130 is described with reference to FIG. 2. Because the second illumination screen 135 may be substantially the same as the first illumination screen 130, an explanation of the second illumination screen 135 is omitted herein for the sake of brevity.

FIG. 2 is a plan view illustrating the first illumination screen 130 shown in FIG. 1.

Referring to FIG. 2, the first illumination screen 130 may include an opaque plate 131, a shutter set 132 and a blinder set 133 according to an example embodiment of the present invention.

A light transmission slit 134 may be formed at a central portion of the opaque plate 131. The light transmission slit 134 may have a substantially rectangular shape. For example, the light transmission slit 134 may be a substantially square-shaped hole. If the light transmission slit 134 and first reticle patterns formed at the first reticle 140 extend in substantially the same directions, a length of the light transmission slit 134 may be substantially larger than lengths of the first reticle patterns.

A shutter set 132 and a blinder set 133 may be arranged on the opaque plate 131. The shutter set 132 may open and close to adjust and/or control transmission through the light transmission slit 134 by adjusting a width of the transmission slit 134. The blinder set 133 may control the length of the light transmission slit 134 to adjust and/or control transmission through the light transmission slit 134.

The shutter set 132 may be adjacent to the light transmission slit 134 to efficiently open and close the light transmission slit 134. That is, the shutter set 132 may determine whether the first illumination light beam 11a is blocked or not. In addition, shutters of the shutter set 132 may move toward and away from each other so that the width of the light transmission slit 134 may be controlled. A control portion 190 may control the blinder set 133.

The control portion 190 may be an electronic system utilized to generally control the exposure process. The control portion 190 may control one or more operations of the exposure apparatus 100 including the blinder set 133, for example.

The shutter set 132 may determine whether the transmission slit 134 transmits the first illumination light beam 11a incident on the first illumination screen 130 or not. The blinder set 133 may control the sectional area of the first illumination light beam 11a transmitted through the transmission slit 134. Similarly, a shutter set of the second illumination screen 135 determines whether a transmission slit of the second illumination screen 135 transmits the second illumination light beam 12a incident on the second illumination screen 135 or not. A blinder set of the second illumination screen 135 may control a sectional area of the second illumination light beam 12a transmitted through the transmission slit of the second illumination screen 135.

As described above, the first and second illumination screens 130 and 135 may have substantially the same or different shapes. In addition, the first and second illumination screens 130 and 135 may have various positions. Furthermore, the shutter sets of the first and second illumination screens 130 and 135 may substantially, simultaneously open or close the light transmission slits of the first and second illumination screens 130 and 135, respectively. Alternatively, the shutter sets of the first and second illumination screens 130 and 135 may alternately open or close the transmission slits of the first and second illumination screens 130 and 135, respectively.

The first illumination light beam 11a transmitted through the first illumination screen 130 may be incident on the first reticle 140, and the second illumination light beam 12a transmitted through the second illumination screen 135 may be incident on the second reticle 150 according to an example embodiment of the present invention. Here, the first and second reticles 140 and 150 may be located on the first and second reticle stages 145 and 155, respectively. The first reticle 140 may be substantially the same as the second reticle 150.

According to an example embodiment of the present invention, the first and second reticles 140 and 150 may be provided with the first and second illumination light beams 11a and 12a, respectively, in a scanning manner. The first reticle stage 145 may move the first reticle 140 in a direction substantially perpendicular to an incident direction of the first illumination light beam 11a in the scanning manner. In addition, the second reticle stage 155 may move the second reticle 150 in a direction substantially perpendicular to an incident direction of the second illumination light beam 12a in the scanning manner.

Alternatively, the first and second reticles 140 and 150 may be provided with the first and second illumination light beams 11a and 12a, respectively, in a stepping manner. Accordingly, the first and second reticles 140 and 150 may move discontinuously in the stepping manner.

As another alternative, the first and second reticles 140 and 150 may be provided with the first and second illumination light beams 11a and 12a, respectively, in a step and scan manner. The step and scan manner is a combination of the scanning manner and the stepping manner.

As described above, the first reticle 140 may have the first reticle patterns. Similarly, the second reticle 150 may have the second reticle patterns. Because the first and second illumination light beams 11a and 12a pass through the first and second reticles 140 and 150, respectively, the first and second illumination light beams 11a and 12a may be changed into the first and second projection lights 11b and 12b, respectively. The first projection light 11b and the second projection light 12b may have first reticle pattern image information and second reticle pattern image information, respectively. The first reticle pattern image information may relate to images of the first reticle patterns. The second reticle pattern image information may relate to images of the second reticle patterns. The first and second projection lights 11b and 12b may be incident on a second optical section 160.

The second optical section 160 may include a condense module 170 and a project screen 180 according to an example embodiment of the present invention.

The condense module 170 may include a first reduction mirror 171, a second reduction mirror 175, a first reflection mirror 173 and a second reflection mirror 177. The first projection light 11b may initially be incident on the first reduction mirror 171 and then incident on the first reflection mirror 173. The second projection light 12b may initially be incident on the second reduction mirror 171 and then incident on the second reflection mirror 177.

The first reduction mirror 171 and the first reflection mirror 173 may reduce a sectional area of the first projection light 11b. The second reduction mirror 175 and the second reflection mirror 177 may reduce a sectional area of the second projection light 12b.

The first and second reduction mirrors 171 and 175 may have substantially the same shape. Further, the first and second reduction mirrors 171 and 175 may be hemispheric. In addition, the first and second reduction mirrors 171 and 175 may have substantially the same functions. The first and second reflection mirrors 173 and 177 may have substantially the same plate shape. In addition, the first and second reflection mirrors 173 and 177 may have substantially the same functions.

For example, the first projection light 11b incident on the first mirror 171 is reflected to the first reflection mirror 173 and the second projection light 12b incident on the second mirror 175 is reflected to the second reflection mirror 177.

According to an example embodiment of the present invention, the first projection light 11b may not intersect with the second projection light 12b. In other words, the advancing path of the first projection light 11b is separate from the advancing path of the second projection light 12b. In addition, the first projection light 11b may not overlap the second projection light 12b according to an example embodiment of the present invention. That is, the first projection light 11b and the second projection light 12b may not affect each other while the first projection light 11b and the second projection light 12b are reduced.

Hereinafter, the first reduction mirror 171 and the first reflection mirror 173 will be described. Because the second reduction mirror 175 and the second reflection mirror 177 are substantially the same as the first reduction mirror 171 and the first reflection mirror 173, respectively, a detailed explanation of the second reduction mirror 175 and the second reflection mirror 177 is omitted herein for the sake of brevity.

The first reduction mirror 171 may be located on an advancing path of the first projection light 11b transmitted through the first reticle 140. The first reduction mirror 171 may reflect the first projection light 11b to condense the first projection light 11b onto the first reflection mirror 173. That is, the first reduction mirror 171 may reduce the first projection light 11b to form a reduced first projection light 11c. The first reflection mirror 173 may be located on an advancing path of the condensed first projection light 11c. The first reflection mirror 173 may change the advancing path of the condensed first light 11c so that the condensed first light 11c may be incident on the project screen 180.

According to an example embodiment of the present invention, a reduction ratio of the condensed first projection light 11c may be controlled by varying a radius of curvature of the first reduction mirror 171 and/or an interval between the first reflection mirror 173 and the first reduction mirror 171.

In addition, one or more optical members may be arranged between the first reduction mirror 171 and the first reflection mirror 173 and may improve optical characteristics of the condensed first projection light 11c.

As described above with respect to an example embodiment of the present invention shown in FIG. 1, the first reduction mirror 171 and the first reflection mirror 173 may condense the first projection light 11b. However, additional reduction mirrors and/or additional reflection mirrors may be utilized to gradually condense the first projection light 11b.

If the first reduction mirror 171 and the first reflection mirror 173 are utilized to condense the first projection light 11b according to an example embodiment of the present invention, a cost of manufacturing the exposure apparatus 100 and a dimension of the exposure apparatus 100 may be reduced. However, a light-condensing member including a condenser lens may also be utilized to condense the first projection light 11b instead of the first reduction mirror 171 and the first reflection mirror 173.

The condensed first and second lights 11c and 12c condensed by the condense module 170 may be incident on the project screen 180 along separated advancing paths according to an example embodiment of the present invention.

The project screen 180 may be located over the photoresist film on the substrate W. Portions of the condensed first and second projection lights 11c and 12c incident on the project screen 180 may be incident onto the photoresist film on the substrate W through the project screen 180.

FIG. 3 is a plan view illustrating the project screen in FIG. 1 according to an example embodiment of the present invention.

Referring to FIG. 3, first and second slits 181 and 182 may be formed in the project screen 180. The first and second slits 181 and 182 may have substantially rectangular shapes. For example, the first and second slits 181 and 182 may be substantially square.

In addition, the first and second slits 181 and 182 may be substantially parallel with each other. If the first reticle patterns of the first reticle 140 are substantially the same as the second reticle patterns of the second reticle 150, a shape and a size of the first slit 181 may be substantially the same as a shape and a size of the second slit 182. On the other hand, if the first reticle patterns of the first reticle 140 are substantially different from the second reticle patterns of the second reticle 150, the shape and the size of the first slit 181 may be substantially different from the shape and the size of the second slit 182.

The condensed first and second projection lights 11c and 12c may be incident on the first and second slits 181 and 182, respectively, of the project screen 180. Thereafter, the condensed first and second projection lights 11c and 12c may partially pass through the first and second slits 181 and 182, respectively, of the project screen 180. Next, the condensed first and second projection lights 11c and 12c may be incident on the photoresist film on the substrate W. That is, the condensed first projection light 11c having the first reticle pattern and the condensed second projection light 12c having the second reticle pattern image information may be incident on the photoresist film on the substrate W. According to an example embodiment of the present invention, the condensed first projection light 11c and the condensed second projection light 12c reach the photoresist film on substrate W by advancing along substantially different paths. The first reticle pattern images and the second reticle pattern images corresponding to the first reticle patterns and the second reticle patterns, respectively, may be projected on the photoresist film on the substrate W.

According to an example embodiment of the present invention, the condensed first and second projection lights 11c and 12c incident on the photoresist film on the substrate W may be spaced apart from each other by an interval between the first and second slits 181 and 182, for example. The first reticle pattern images and the second reticle pattern images may be projected onto the photoresist film on the substrate W at the same or different times. Stated differently, the condensed first and second projection lights 11c and 12c may be substantially simultaneously incident or subsequently incident on the photoresist film on the substrate W.

According to an example embodiment of the present invention, one or more sensor modules 185 may send a signal downward from the project screen 180 to measure a distance between the project screen 180 and the photoresist film on the substrate W. For example, one or more sensor modules 185 may be arranged on or around the project screen 180 and may send a signal toward the photoresist film on the substrate W. The sensor module 185 may then collect the signal reflected by the photoresist film on the substrate W to measure the distance between the project screen 180 and the photoresist film on the substrate W. The signal sent toward the photoresist film on the substrate W may have a spot shape or beam shape, for example. The sensor module 185 may provide the control portion 190 with information concerning the distance. The control portion 190 may control a position of the project screen 180 with respect to the photoresist film on the substrate W and a gradient of the project screen 180 with respect to the photoresist film on the substrate W on the basis of the information, for example.

The substrate W may be located on a substrate stage 195. The substrate stage 195 may support the substrate W. In addition, the substrate stage 195 may move the substrate W horizontally and/or vertically. In this case, a movement direction of the substrate W may be substantially opposite to the movement directions of the first and second reticles 140 and 150 described above. Movement speeds of the first and second reticles 140 and 150 may determine a movement speed of the substrate W.

According to an example embodiment of the present invention, the photoresist film on the substrate W may be exposed by the condensed first and second projection lights 11c and 12c in a scanning manner. Accordingly, the substrate W may continuously move in the direction substantially opposite to the movement directions of the first and second reticle 140 and 150 in the scanning manner.

As an alternative, the photoresist film on the substrate W may be exposed by the condensed first and second projection lights 11c and 12c in a stepper manner.

As another alternative, the photoresist film on the substrate W may be exposed by the condensed first and second projection lights 11c and 12c in a step and scan manner.

In addition, intensities of lights reflected from the photoresist film on the substrate W may be measured to control intensities of the condensed first and second projection lights 11c and 12c. Thus, the photoresist patterns may be precisely formed on the substrate W. Hereinafter, a method for exposing a film on a substrate to light will be described.

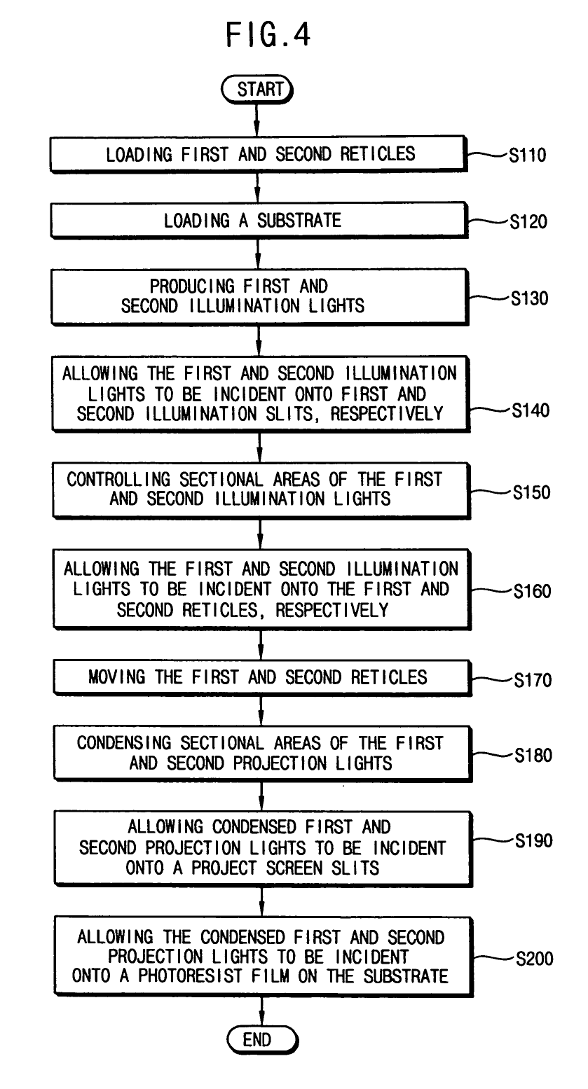

FIG. 4 is a flow chart illustrating the method for exposing the film on the substrate to light in accordance with an example embodiment of the present invention.

Referring to FIGS. 1 to 4, first and second reticles 140 and 150 may be loaded onto first and second reticle stages 145 and 155, respectively, as illustrated by step S110 of FIG. 4. First reticle patterns and second reticle patterns may be formed at the first reticle 140 and the second reticle 150, respectively. The first reticle patterns may be substantially the same as or different from the second reticle patterns.

A substrate W may be loaded onto a substrate stage 195 as illustrated by step S120. A photoresist film (not shown) may be formed on the substrate W. An exposure process and a development process may be performed on the photoresist film to form photoresist patterns. For example, the substrate W may be coated with a photoresist composition by a coating process so that a preliminary photoresist film may be formed on the substrate W and a soft bake process may be performed on the preliminary photoresist film to form the photoresist film on the substrate W. The photoresist patterns may be used as an etch mask and/or an ion implantation mask. In addition, the photoresist film on the substrate W may include a plurality of shoot regions and each shoot region may have at least one die region.

As illustrated by step S130 of FIG. 4, first and second illumination light beams 11a and 12a may be produced. The first and second illumination light beams 11a and 12a may be produced by separate light sources or by separating the first and second illumination light beams 11a and 12a from an initial light 10 produced by a single light source 122. The number of illumination light beams may be substantially the same as the number of reticles. For example, two reticles are employed in the above method to produce two illumination light beams according to an example embodiment of the present invention. However, at least three reticles may be employed in a method according to an example embodiment of the present invention.

The first and second illumination light beams 11a and 12a may include deep ultraviolet rays having wavelengths ranging from about 100 nm to about 300 nm or extreme ultraviolet rays having wavelengths of no more than about 100 nm. The first and second illumination light beams 11a and 12a may have substantially the same wavelengths and intensities. However, the first and second illumination light beams 11a and 12a may have substantially different wavelengths and intensities.

The first and second illumination light beams 11a and 12a may be incident on first and second illumination screens 130 and 135, respectively, as illustrated by step S140 of FIG. 4. According to an example embodiment of the present invention, the first and second illumination light beams 11a and 12a may have substantially different advancing paths. The advancing paths are substantially parallel with each other. In addition, the first and second illumination light beams 11a and 12a may have substantially the same luminous intensities.

Whether the first and second illumination screens 130 and 135 transmit the first and second illumination light beams 11a and 12a, respectively, or not may be determined. In addition, if the first and second illumination screens 130 and 135 transmit the first and second illumination light beams 11a and 12a, respectively, sectional areas of the first and second illumination light beams 11a and 12a may be controlled as illustrated by step S150 of FIG. 4. A shutter set 130 and a blinder set 133 installed at the first and second illumination screens 130 and 135 may be used to control the sectional areas of the first and second illumination light beams 11a and 12, respectively. The second illumination screen 135 may be substantially the same as the first illumination screen 130. Alternatively, the second illumination screen 135 may be substantially different from the first illumination screen 130. That is, many apparent variations of the second illumination screen 135 with respect to the first second illumination screen 130 may be possible. As one example, the first illumination screen 130 may be substantially perpendicular to the second illumination screen 135. As another example, the first illumination screen 130 may be longer than the second illumination screen 135.

The first and second illumination light beams 11a and 12a transmitted through the first and second illumination screens 130 and 135, respectively, may be incident on the first and second reticles 140 and 150, respectively, as illustrated by step S160 of FIG. 4. According to an example embodiment of the present invention, the first and second illumination screens 130 and 135 may be alternately opened and closed. Accordingly, points in time when the first and second illumination light beams are incident on the first and second reticles 140 and 150 may be controlled.

The first and second reticles 140 and 150 may be moved using the first reticle stage and second reticle stage 145 and 155, respectively, in directions substantially perpendicular to incident directions of the first and second illumination light beams 11a and 12a as illustrated by step S170 of FIG. 4. The first and second reticles 140 and 150 may be substantially simultaneously moved or moved at different times.

The first illumination light beam 11a may be transmitted through the first reticle 140 to change the first illumination light beam 11a into the first projection light 11b, which may have first reticle pattern image information. The second illumination light beam 12a may be transmitted through the second reticle 150 through the second reticle 150 to change the second illumination light beam 12a into the second projection light 12b, which may have second reticle pattern image information. The first reticle pattern image information may relate to images of the first reticle patterns included in the first reticle 140, and the second reticle pattern image information may relate to images of the second reticle patterns included in the second reticle 150. That is, the first illumination light beam 11a and the second illumination light beam 12a may be changed into first projection light 11b having the first reticle pattern image information and second projection light 12b having the second reticle pattern image information, respectively. Sectional areas of the first and second projection lights 11b and 12b transmitted through the first and second reticles 140 and 150, respectively, may be reduced. That is, the first and second projection lights 11b and 12b transmitted through the first and second reticles 140 and 150 may be condensed as illustrated by step S180 of FIG. 4. Thus, the first and second projection lights 11b and 12b may be changed into condensed first and second projection lights 11c and 12c, respectively. First and second reduction mirrors 171 and 175 having substantially hemispheric shapes may be utilized to condense the first and second projection lights 11b and 12b, respectively. Alternatively, light-condensing members including condenser lenses may be utilized to condense the first and second projection lights 11b and 12b. A reduction ratio of the condensed first projection light 11c may be controlled by varying a radius of curvature of the first reduction mirror 171 and/or an interval between the first reduction mirror 171 and the first reflection mirror 173. In addition, a reduction ratio of the condensed second projection light 12c may be controlled by varying a radius of curvature of the second reduction mirror 173 and/or an interval between the second reduction mirror 175 and the second reflection mirror 177. One or more additional optical members may be arranged between the first reduction mirror 171 and the first reflection mirror 173 to improve optical characteristics of the condensed first projection light 11c. Similarly, one or more additional optical members may be arranged between the second reduction mirror 175 and the second reflection mirror 177 to improve optical characteristics of the condensed second projection light 12c.

The condensed first and second projection lights 11c and 12c may be incident on the project screen 180 as illustrated by step S190 of FIG. 4. First and second slits 181 and 182, which may have substantially rectangular shapes, may be formed in the project screen 180. A shape and a size of the first slit 181 may be substantially the same as the shape and size of the second slit 182. However, if the first reticle patterns are substantially different from the second reticle patterns, the shape and the size of the first slit 181 may be substantially different from the shape and size of the second slit 182.

The condensed first and second projection lights 11c and 12c partially transmitted through the first and second slits 181 and 182, respectively, may be incident on the photoresist film on the substrate W as illustrated by step S200 of FIG. 4. For example, the condensed first projection light 11c having the first reticle pattern image information and the condensed second projection light 12c having the second reticle pattern image information are incident on the photoresist film on the substrate W and advance along substantially different advancing paths. Thus, the first reticle pattern images of the first reticle patterns may be projected onto the photoresist film on the substrate W and the second reticle pattern images of the second reticle patterns may be projected onto the photoresist film on the substrate W.

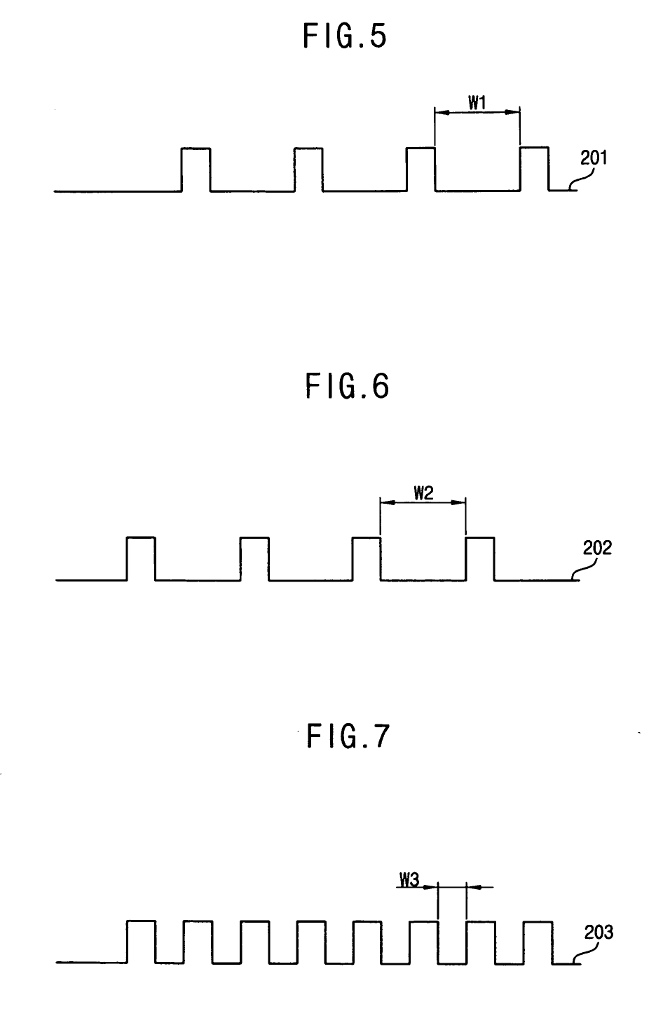

FIG. 5 is a schematic view illustrating first reticle pattern images according to an example embodiment of the present invention. FIG. 6 is a schematic view illustrating second reticle pattern images according to an example embodiment of the present invention. FIG. 7 is a schematic view illustrating third reticle pattern images projected on the photoresist film on the substrate W according to an example embodiment of the present invention. The third reticle pattern images are created using a combination of the first and second reticle pattern images shown in FIGS. 5 and 6.

Referring to FIG. 1 and FIGS. 5 to 7, the first reticle pattern image 201 may correspond to the first reticle pattern having a substantial line shape. The first reticle pattern images may be spaced apart from each other by first intervals W1. The second reticle pattern image 202 may correspond to the second reticle pattern having a substantial line shape. The second reticle pattern images may be spaced apart from each other by a second interval W2.

The condensed first projection light 11c may project the first reticle pattern images 201 on the photoresist film on the substrate W. The condensed second projection light 12c may project the second reticle pattern images 202 on the photoresist film on the substrate W. The first and second reticles 140 and 150 may move in a first direction D1 as shown in FIG. 1. The substrate W may move in a second direction D2 substantially opposite to the first direction D1.

The second reticle pattern image 202 may be shifted by a third width W3 with respect to the first reticle pattern image 201 so that the second reticle pattern image 202 may be located between the first reticle pattern images 201 that are adjacent to each other. The third interval W3 may be substantially smaller than the first and second intervals W1 and W2. The first interval W1 may be substantially the same as the second interval W2. If the first interval W1 is substantially the same as the second interval W2, the third interval W3 may be about half the first interval W1.

The movements of the first and second reticles 140 and 150 may be controlled with respect to time so that the second reticle pattern image 202 may be shifted with respect to the first reticle pattern image 210. As one alternative, an interval between the first and second slits 181 and 182 of the project screen 180 may be controlled so that the second reticle pattern image 202 may be shifted with respect to the first reticle pattern image 210. As another alternative, positions of the first reticle patterns with respect to the first reticle 140 may be substantially different from those of the second reticle patterns with respect to the second reticle 150 so that the second reticle pattern image 202 may be shifted with respect to the first reticle pattern image 210.

As described above, if the condensed first and second projection lights 11c and 12c are projected onto the photoresist film on the substrate W, the third reticle pattern images 203 spaced apart from each other by the third intervals W3 may be obtained without forming a substitute reticle having third reticle patterns having images substantially the same as the third reticle pattern images 203. That is, the third reticle pattern images 203 may be efficiently obtained using the first and second reticles 130 and 135 instead of using the substitute reticle. Accordingly, if the condensed first projection light 11c alone is incident on the photoresist film on the substrate W, shapes of the photoresist patterns on the substrate W may correspond to the first reticle pattern images 201. That is, critical dimensions of the photoresist patterns may be substantially the same as the first intervals W1. Further, if the condensed second projection light 12c alone is incident onto the photoresist film on the substrate W, the shapes of the photoresist patterns on the substrate W may correspond to the second reticle pattern images 202. That is, the critical dimensions of the photoresist patterns may be substantially the same as the second intervals W2. However, if the condensed first and second projection lights 11c and 12c are simultaneously incident on the photoresist film on the substrate W, the shapes of the photoresist patterns on the substrate W may correspond to the third reticle pattern image 203. That is, the critical dimensions of the photoresist patterns may be substantially the same as the third intervals W3, which may be substantially smaller than the first and second intervals W1 and W2. As described above, the third reticle pattern images 203 may be efficiently obtained using the first and second reticles 140 and 150 instead of using a substitute reticle. Thus, a margin of a resolution required for forming the photoresist patterns may increase. That is, the photoresist patterns with critical dimensions substantially the same as the third intervals W3 may be efficiently formed by using an exposure apparatus having a resolution capable of achieving the first interval W1 or the second interval W2. In addition, because the condensed first and second projection lights 11c and 12c are projected onto the photoresist film on the substrate W along separate advancing paths, optical characteristics of the first and second reticle images 201 and 202 may be improved as compared with conventional devices.

If the condensed first and second projection lights 11c and 12c are simultaneously projected onto the photoresist film on the substrate W in a scanning manner, the condensed first and second projection lights 11c and 12c may overlap between die regions. For example, the condensed second projection light 12c may remain projected on a first die region while the condensed first light 11c may be projected on a second die region after a projection of the condensed first light 11c onto the first die region is already finished. Similarly, the condensed second projection light 12c may be projected between the first and second die regions while the condensed first light 11c is projected on the second region after the projection of the condensed first light 11c on the first die region is already finished. That is, the condensed second projection light 11b subsequent to the condensed first projection light 11a may have an influence on the first die region or between the first and second die regions. To suppress this influence, points in time when the condensed first and second projection lights 11c and 12c are projected onto the photoresist film on the substrate W may be controlled. The first and second illumination screens 130 and 135 may be alternately opened and closed by the shutter sets to control the projections.

If fine structures are already formed on the substrate W, the photoresist film formed on the substrate W to cover the fine structures may be uneven. Similarly, if a thin film is already formed on the substrate W, the photoresist film formed on the substrate W to cover the thin film may also be uneven. In these cases, an interval between the project screen 180 and the photoresist film may not be uniform. If the interval is not uniform, depth of focus (DOF) of the exposure apparatus may be affected. That is, the DOF of the exposure apparatus may not be uniform. Thus, according to an example embodiment of the present invention, the interval between the project screen 180 and the photoresist film is maintained substantially constant. This interval may be controlled using the sensor module 185 arranged on the project screen 180.

According to example embodiments of the present invention as described above, the first reticle patterns may be substantially the same as or substantially different from the second reticle patterns.

According to example embodiments of the present invention, images of at least two reticles may be rapidly projected onto a film on a substrate. In addition, the images may not interfere with each other at least in part due to the separate, non-intersecting advancing paths. Thus, superior photoresist patterns may be formed. In addition, a resolution margin of an exposure apparatus may be about twice that of a resolution margin of a conventional exposure apparatus. As a result, a superior exposure effect may be obtained in a relatively short time. That is, a large amount of the superior photoresist patterns may be rapidly obtained.

The foregoing example embodiments are illustrative of the present invention and are not to be construed as limiting thereof. Although a few embodiments of this invention have been described, those skilled in the art will readily appreciate that many modifications are possible without materially departing from the teachings and advantages of this invention. Accordingly, all such modifications are intended to be included within the scope of this invention. Therefore, it is to be understood that the foregoing is illustrative of the present invention and is not to be construed as limited to the specific embodiments disclosed, and that modifications to the disclosed embodiments, as well as other embodiments, are intended to be included within the scope of the present invention.

What is claimed is:

1. A method for exposing an object to light, the method comprising:
producing projection lights each having image information; and
projecting the projection lights onto the object along separate, advancing paths.

2. The method of claim 1, wherein the separate, advancing paths do not intersect.

3. The method of claim 1, wherein producing the projection lights comprises:
producing illumination light beams proceeding along separate, advancing paths; and
passing the illumination light beams through reticle patterns to create the projection lights.

4. The method of claim 3, further comprising:
moving the reticle patterns in a first direction; and
moving the object in a second direction substantially opposite to the first direction.

5. The method of claim 3, further comprising:
separating an initial light to create the illumination light beams.

6. The method of claim 1, wherein projecting the projection lights comprises:
projecting a first projection light of the projection lights onto the object at a first time; and
projecting another projection light of the projection lights onto the object at a second time.

7. The method of claim 6, wherein the first time is different from the second time.

8. The method of claim 1, further comprising:
passing the projection lights through a projection screen; and
maintaining a distance between the projection screen and the object.

9. An exposure apparatus comprising:
a first optical section producing projection lights each having image information; and
a second optical section projecting the projection lights onto an object along separate, advancing paths.

10. The exposure apparatus of claim 9, wherein the first optical section comprises:
an illumination module producing first and second illumination light beams;
a first reticle having first reticle patterns, the first reticle transmitting the first illumination light beam to change the first illumination light beam into a first projection light having first reticle pattern image information relating to images of the first reticle patterns; and
a second reticle having second reticle patterns, the second reticle transmitting the second illumination light beam to change the second illumination light beam into a second projection light having second reticle pattern image information relating to images of the second reticle patterns.

11. The exposure apparatus of claim 10, wherein the illumination module comprises:
a first light source producing the first illumination light beam; and
a second light source producing the second illumination light beam.

12. The exposure apparatus of claim 10, wherein the illumination module comprises:
a light source producing an initial light; and
at least one beam splitter separating the initial light into the first and second illumination light beams.

13. The exposure apparatus of claim 10, further comprising:
a first illumination screen arranged between the illumination module and the first reticle, the first illumination screen having a first light transmission slit having a substantially rectangular shape; and
a second illumination screen arranged between the illumination module and the second reticle, the second illumination screen having a second light transmission slit having a substantially rectangular shape.

14. The exposure apparatus of claim 13, further comprising:
a first blinder set arranged on the first illumination screen to adjust a width of the first light transmission slit; and
a second blinder set arranged on the second illumination screen to adjust a width of the second light transmission slit.

15. The exposure apparatus of claim 10, further comprising:
a first reticle stage moving the first reticle in a direction substantially perpendicular to an incident direction of the first illumination light beam; and
a second reticle stage moving the second reticle in a direction substantially perpendicular to an incident direction of the second illumination light beam.

16. The exposure apparatus of claim 9, wherein the second optical section comprises:
a condense module condensing the projection lights; and
a project screen located over the object, the project screen having a slit through which the projection lights are transmitted, the slit having a substantially rectangular shape.

17. The exposure apparatus of claim 16, wherein the condense module comprises a reduction mirror having a substantially hemispheric shape.

18. The exposure apparatus of claim 16, further comprising a sensor module arranged on the project screen, the sensor module sending a signal toward the object to measure a distance between the project screen and the object.

19. The exposure apparatus of claim 9, further comprising:
a substrate stage supporting a substrate, the substrate stage moving the substrate horizontally,
wherein the object is the substrate.
